(19) United States
(12) Patent Application Publication
(10) Pub. No.: US 2015/0043097 A1
(43) Pub. Date: Feb. 12, 2015

(54) PERSONAL VIEWING DEVICE MOUNTED TO A TOILET OR TOILET SEAT

(71) Applicant: Roy E. Sroka, South Barrington, IL (US)

(72) Inventor: Roy E. Sroka, South Barrington, IL (US)

(21) Appl. No.: 13/961,932

(22) Filed: Aug. 8, 2013

(51) Int. Cl. A47K 17/02; G02B 5/08

(52) U.S. Cl. CPC A47K 17/02; G02B 5/08
USPC 359/872; 29/428

(57) ABSTRACT

A personal viewing device that may be mounted to the bottom surface of a toilet seat or to the rim of a toilet. The personal viewing device may include a support member with a first end and a second end. The first end may be a handle and a reflective panel may be attached to the second end. The viewing device may be in a contracted form and an expanded form. The contracted form may include the panel being positioned underneath the toilet seat, and an expanded form may include the panel protruding from the inside edge of the toilet seat

### BACKGROUND OF THE INVENTION

The present invention relates to a personal viewing device and, more particularly, to a personal viewing device mounted to a toilet or toilet seat.

When evacuating solid waste from the body, cleaning oneself completely may be difficult for some people. In particular, positively ensuring that the underside of oneself is completely clean is currently not possible, unless the user gets up and off of the toilet and locates a mirror or requests assistance from another person. Further, the inspection of one's underside due to irritation or other chronic medical issues and the like is not possible using the current toilet and toilet seats available in the marketplace.

As can be seen, there is a need for a discreet viewing device that may be used easily while remaining seated on a toilet.

### SUMMARY OF THE INVENTION

In one aspect of the present invention, a personal viewing device comprises: a support member comprising a first end, and a second end, wherein the first end comprises a handle; and a panel comprising a reflective portion, wherein the panel is attached to the second end of the support member; wherein the support member is mounted to a bottom surface of a toilet seat or below the toilet seat to the rim of a toilet.

In another aspect of the present invention, a method of mounting a personal viewing device to a toilet seat comprises: providing a personal viewing device comprising: a support member comprising a first end, and a second end, wherein the first end comprises a handle; and a panel comprising a reflective portion, wherein the panel is attached to the second end of the support member; attaching the personal viewing device to a pivot mount; and mounting the pivot mount to the bottom surface of a toilet seat.

These and other features, aspects and advantages of the present invention will become better understood with reference to the following drawings, description and claims.

### BRIEF DESCRIPTION OF THE DRAWINGS

FIG. 1 is a top perspective view of the present invention shown in use;

FIG. 2 is a top detail perspective view of the present invention with the viewing device of FIG. 1 in contracted form;

FIG. 3 is a detail perspective view of the present invention with the viewing device of FIG. 1 in the expanded form;

FIG. 4 is a bottom perspective view of the present invention demonstrated on the toilet seat and demonstrated in the contracted form;

FIG. 5 is a bottom perspective view of the present invention demonstrated on the toilet seat and demonstrated in the expanded form;

FIG. 6 is a top perspective view of the present invention;

FIG. 7 is a bottom perspective view of the present invention;

FIG. 8 is a bottom perspective view of the present invention demonstrating a pivoting motion;

FIG. 9 is a bottom perspective view of the present invention demonstrating a pivoting motion; and

FIG. 10 is a bottom perspective view of the present invention demonstrating a sliding motion.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a personal viewing device that may be mounted to the bottom surface of a toilet seat or to the underside of a toilet seat. The personal viewing device may include a support member with a first end and a second end. The first end may be a handle and a reflective panel may be attached to the second end. The viewing device may be in a contracted form and an expanded form. The contracted form may include the panel being positioned underneath the toilet seat, and the expanded form may include the panel protruding from the inside edge of the toilet seat

The present invention may include a mirror mounted to a toilet seat or to the rim of a toilet. The mirror may be attached to a lever system that is affixed to and stored on the bottom surface of a toilet seat and may be extended by the user for viewing their underside. The present invention may allow a user to privately view their underside when necessary and neatly store the device when not in use.

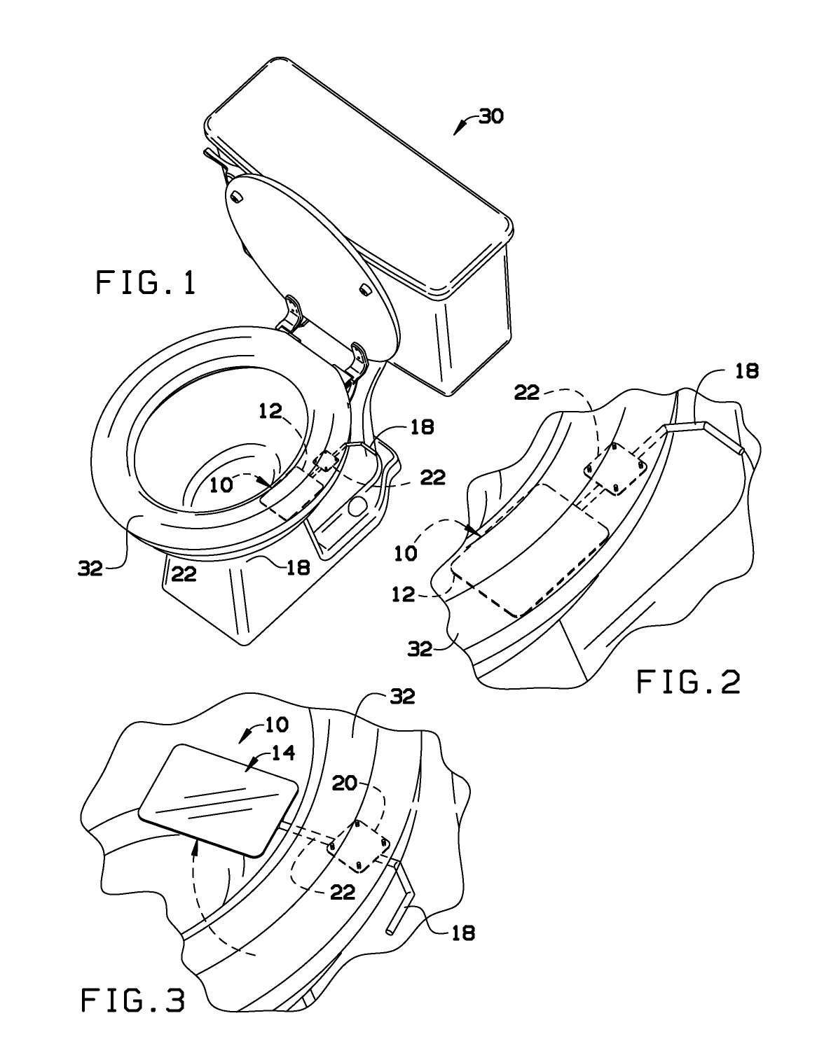

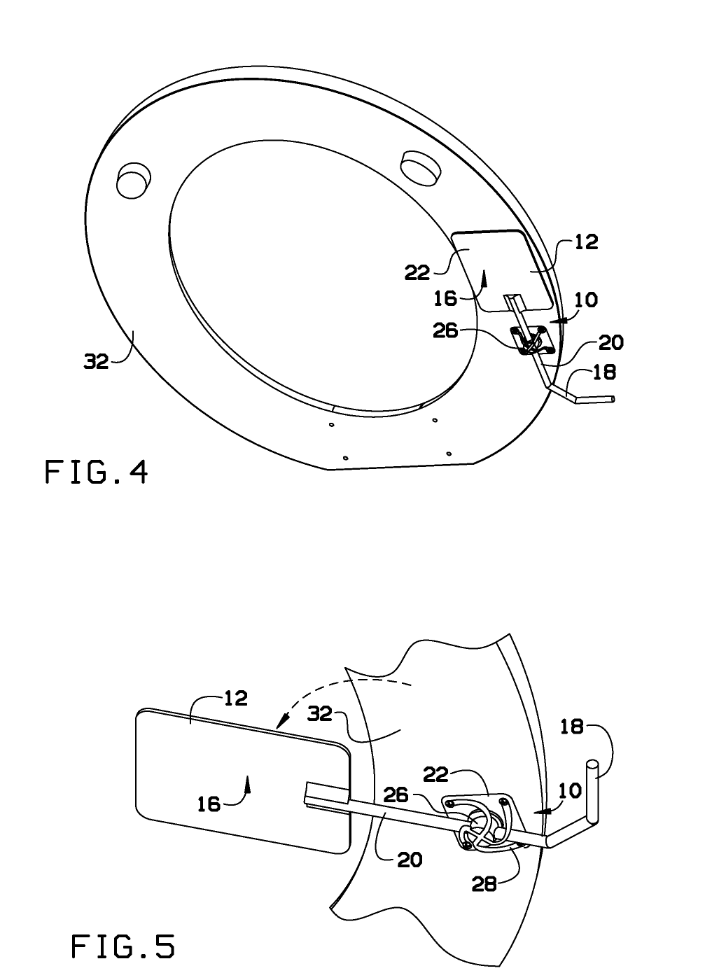

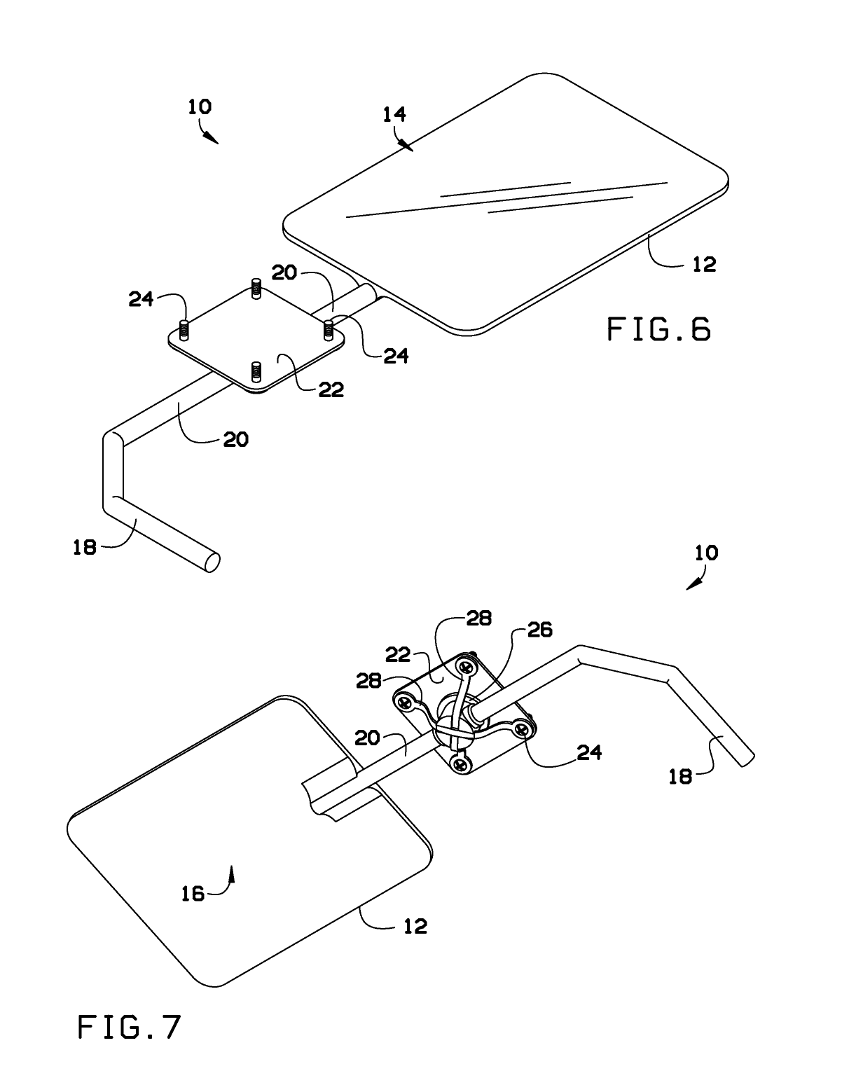

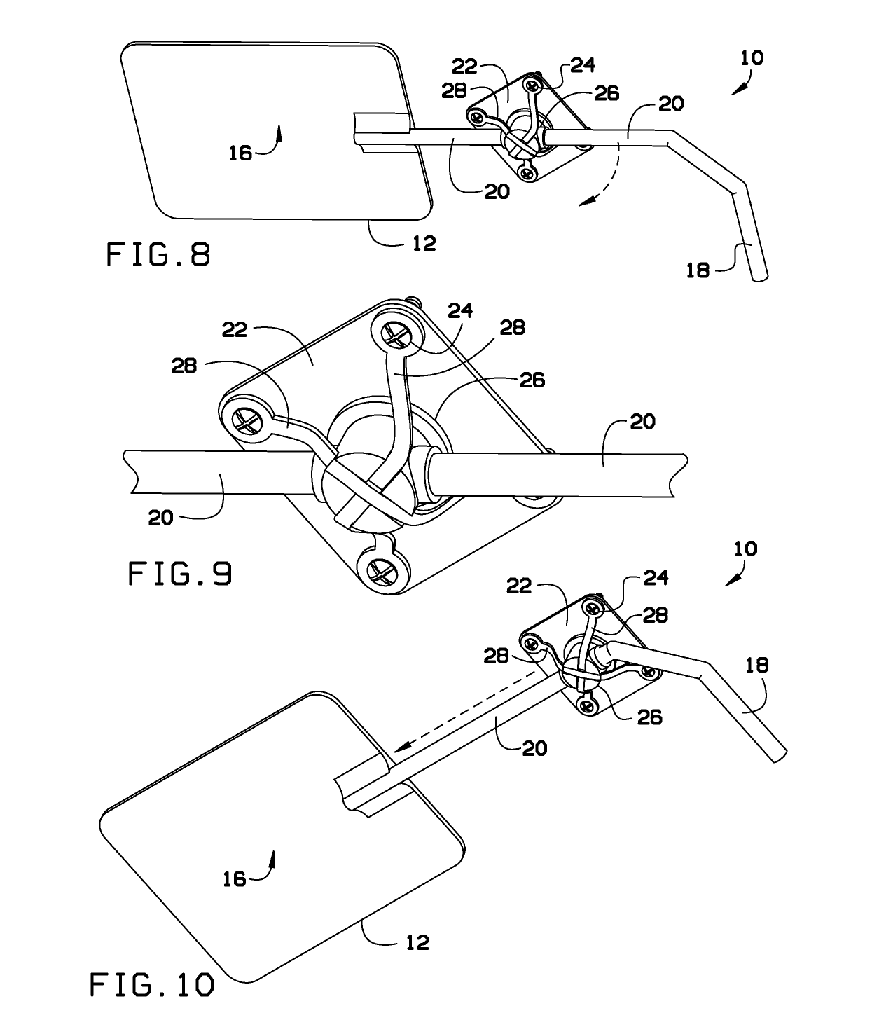

Referring to FIGS. 1 through 10, the present invention may include a personal viewing device 10. The viewing device 10 may include a support member 20, such as a rod. The support member 20 may include a first end and a second end. The first end of the support member 20 may include a handle 18. A panel 12 that has a reflective surface 16 may be attached to the second end of the support member 20. The support member 20 may be mounted to a bottom surface of a toilet seat 32, with the reflective surface 16 facing towards the toilet seat 32.

In certain embodiments, the panel 12 of the present invention may be a mirror for viewing an underside of a user while sitting on a toilet 30. The toilet seat 32 may include an inside edge and an outside edge. As illustrated in the Figures, the handle 18 may protrude from underneath the toilet seat 32 passed the outside edge. Therefore, a user may easily grasp the handle 18 when the user would like to use the viewing device 10. The viewing device 10 may be in a contracted form, in which the panel 12 is substantially underneath the toilet seat 32, and an expanded form when the panel 12 is protruding passed the inside edge of the toilet seat 32. The user may pivot or slide the support member 20 using the handle 18, and the reflective panel 10 may be moved from the contracted form to the expanded form.

As mentioned above, the support member 20 may be pivotally connected to the toilet seat 32. In certain embodiments, the support member 20 and panel 12 may be biased in the contracted position. For example, the panel 12 may be spring biased in the contracted position. Therefore, a user may use the handle 18 to pivot the viewing device 10 from the contracted to the expanded form and then release the handle 18 for the viewing device 10 to bias back to the contracted form.

The present invention may be pivotally mounted to the toilet seat 32 by any method known in the art. For example, as illustrated, the present invention may include a mounting bracket 22 secured to the underside of the toilet seat 32 by glue or fasteners 24. The mounting bracket 22 may include a pivot mount 26. The support member 20 may be attached to the pivot mount 26, so that the support member 20 may pivot relative to the mounting bracket 22. In certain embodiments, resistance straps 28 may be attached to the fasteners 24 and run through grooves in the pivot mount 26. This may bias the viewing device in the contracted position.

As illustrated in FIG. 10, the support member 20 and panel 16 may be adjusted by pushing and pulling the support member 20. Therefore, the support member 20 may be slidably connected to the bottom surface of the toilet seat 32. For example, the support member 20 may be slidably connected to the pivot mount 26. In certain embodiments, the pushing and pulling of the support member 20 may be used to move the present invention from the contracted form to the expanded form and inversely from the expanded form to the contracted form. However, pushing and pulling the support member 20 may also be used to adjust the mirror to the optimal viewing position.

A method of mounting a personal viewing device to a toilet seat may include the following: providing a personal viewing device that may include a support member having a first end, and a second end, the first end may include a handle; and a panel having a reflective portion, the panel may be attached to the second end of the support member; attaching the personal viewing device to a pivot mount; and mounting the pivot mount to the bottom surface of a toilet seat.

The present invention may include dimensions that facilitate a pivoting mirror that is mounted to the bottom surface of a toilet seat. For example, the mirror may be around 2½ inch by 3½ inch by 1/8 of an inch; the metal or plastic support member may be around 3 to 4 inches by 1/8 inch; the square metal or plastic mounting component may be around 2 inch by 2 inch by 1/16 of an inch; the resistance straps may be around ½ inch in length, the pivot mount may be around ¼ inch, and the handle may be around 1½ to 2 inches by ¼ inch.

It should be understood, of course, that the foregoing relates to exemplary embodiments of the invention and that modifications may be made without departing from the spirit and scope of the invention as set forth in the following claims.

What is claimed is:

1. A personal viewing device comprising:
a support member comprising a first end, and a second end, wherein the first end comprises a handle;
a panel comprising a reflective portion, wherein the panel is attached to the second end of the support member;
wherein the support member is mounted to a bottom surface of a toilet seat or to the rim of the toilet.

2. The personal viewing device of claim 1, wherein the toilet seat comprises an inside edge and an outside edge, and wherein the handle is protruding from the outside edge.

3. The personal viewing device of claim 2, further comprising a contracted form, wherein the panel is underneath the toilet, and an expanded form wherein the panel is protruding from the inside edge of the toilet seat.

4. The personal viewing device of claim 1, wherein the support member is pivotally mounted to the bottom surface of the toilet seat.

5. The personal viewing device of claim 1, wherein the support member is slidably connected to the bottom surface of the toilet seat.

6. The personal viewing device of claim 1, wherein the panel is a mirror.

7. The personal viewing device of claim 3, wherein the personal viewing device is biased in a contracted form.

8. The personal viewing device of claim 3, further comprising a mounting component comprising:
a mounting bracket mounted to the bottom surface of the toilet seat or to the rim of a toilet and
a pivot mount attached to the mounting bracket,
wherein the support member is attached to the pivot mount and thereby pivots relative to the mounting bracket.

9. The personal viewing device of claim 8, wherein the mounting component further comprises fasteners attaching the mounting bracket to the toilet seat or to the rim of a toilet

10. The personal viewing device of claim 8, wherein the mounting component further comprises at least one resistance strap biasing the personal viewing device in a contracted position.

11. A method of mounting a personal viewing device to a toilet seat comprising:
providing a personal viewing device comprising:
a support member comprising a first end, and a second end, wherein the first end comprises a handle; and
a panel comprising a reflective portion, wherein the panel is attached to the second end of the support member; and
mounting the personal viewing device to the bottom surface of a toilet seat or to the rim of a toilet.

12. The method of claim 11, wherein the personal viewing device is pivotally mounted to the bottom of the toilet seat or to the rim of a toilet.

13. The method of claim 11, wherein the personal viewing device is slidably attached to the bottom of the toilet seat.
